(19) United States
(12) Patent Application Publication
(10) Pub. No.: US 2013/0332970 A1
(43) Pub. Date: Dec. 12, 2013

(54) METHOD AND APPARATUS FOR REPRODUCING STREAMING PLAYLIST AND INFORMATION STORAGE MEDIUM STORING STREAMING PLAYLIST

(71) Applicant: SAMSUNG ELECTRONICS CO., LTD., Suwon-si (KR)

(72) Inventors: Min-seok KIM, Suwon-si (KR); Hong-seok PARK, Anyang-si (KR); Bong-gil BAK, Suwon-si (KR); Jong-ho YANG, Yongin-si (KR); Jae-jun LEE, Suwon-si (KR); Yong-seok JANG, Hwaseong-si (KR)

(21) Appl. No.: 13/897,058

(22) Filed: May 17, 2013

Related U.S. Application Data
(60) Provisional application No. 61/657,112, filed on Jun. 8, 2012.

(30) Foreign Application Priority Data
Sep. 6, 2012 (KR) 10-2012-0098854

(51) Int. Cl. H04N 9/87

(52) U.S. Cl. CPC H04N 9/87
USPC 725/88; 386/241

(57) ABSTRACT

A method and apparatus for reproducing a playlist, and an information storage medium including executable instructions for performing the method are provided. The method includes: determining whether the playlist is a streaming playlist; when it is determined that the playlist is a streaming playlist, receiving stream data from a server; generating, based on preset standards, a clip AV stream file from the received stream data and storing the generated clip AV stream file; and reproducing the stored clip AV stream file, wherein stored clip AV stream file is reproduced according to a network status between the server and a reproduction apparatus.

### CROSS-REFERENCE TO RELATED PATENT APPLICATIONS

This application claims priority from Korean Patent Application No. 10-2012-0098854, filed on Sep. 6, 2012 in the Korean Intellectual Property Office, and U.S. Provisional Application No. 61/657,112, filed on Jun. 8, 2012 in United States Patent and Trademark Office, the disclosures of which are incorporated herein in their entirety by reference.

### BACKGROUND

1. Field

Methods and apparatuses consistent with exemplary embodiments relate to reproduction of a Blu-ray disc (BD)-based playlist, and more particularly, to a method and apparatus for reproducing a clip audio/video (AV) stream with an appropriate capacity or image quality based on a network environment between a server and a reproduction apparatus, and an information recording medium storing computer executable instructions for performing the method.

2. Description of the Related Art

In order to reproduce a Blu-ray disc (BD)-based playlist, three types of files are needed That is, a movie playlist file (xxxxx.mpls), a clip information file (zzzzz.clpi), and a clip AV stream file (zzzzz.m2ts) are needed. In general, the three types of files are stored in a read-only information storage medium such as a BD or in a readable/recordable non-volatile memory. However, for example, a progressive playlist may be reproduced by downloading a clip AV stream file from a contents providing server even if the clip AV stream file is not stored in an information storage medium. Also, even if all clip AV stream files corresponding to the entire section of the playlist have not been downloaded, it is still possible to reproduce the playlist.

In order to reproduce content on a network, the following process is performed. First, an application in a disk or memory (e.g., Blu-ray disc Java (BD-J) application) communicates with a server that stores content to download files of the above-mentioned three types (e.g., a movie playlist file, a clip information file, and a clip AV stream file). Among the files of the three types, some may be stored in a disk or a memory in advance. In general, the playlist file and the clip information file, which both have a relatively small capacity are downloaded first, and then the clip AV stream file which has a relatively large capacity is downloaded thereafter. While the playlist is being reproduced, the clip AV stream file which has not yet been completely downloaded, is continuously downloaded until it has been downloaded in its entirety.

According to the conventional art, a clip AV stream file described in a clip information file cannot be modified during reproduction of a playlist. If a network becomes unstable during reproduction of the playlist and a download speed of the clip AV stream file is degraded, a reproduction apparatus continuously downloads a clip AV stream file that is designated in the clip information file. If there is no data to be reproduced, a data starved event is generated, and there is no alternative to prevent the data starved event. Specifically, a data starved even occurs when the data is not ready to be reproduced.

FIG. 1 illustrates a situation in which a data starved event is generated when a clip AV stream file which is not completely downloaded is to be reproduced. A playlist #1 100 includes a plurality of play items #1 111, #2 112, . . . #n 11n, and clip information files respectively corresponding to the plurality of play items are provided. In each clip information file, an appointed clip AV stream file is provided. For example, a clip information file 01001.clpi 121 corresponds to the clip AV stream file 01001.m2ts 131, and clip information file 01002.clpi 122 corresponds to clip AV stream file 01002.m2ts 132. Assuming a situation where clip AV stream files from 01001.m2ts 131 to 01004.m2ts 134 are downloaded, but clip AV stream files from 01005.m2ts 135 are not yet downloaded, clip information files are sequentially reproduced starting from 01001.m2ts 131 of the playlist #1 100. However, when clip AV stream file 01005.m2ts 135 is about to be reproduced, a data starved event is generated since clip AV stream file 01005.m2ts 135 has not yet been downloaded.

The possibility of a data starved event is also increased due to multi-speed reproduction of the playlist. Even in a network in which reproduction of a playlist is supported for a normal speed, a download speed of a clip AV stream file in the network may not be sufficient for reproduction at double the normal speed.

A data starved event may be generated when a user modifies a reproduction position to a clip AV stream file that has not yet been received. FIG. 2 illustrates a situation in which a data starved event is generated because a stream to be reproduced is not yet prepared when a user modifies a reproduction position. In FIG. 2, a reproduction position is modified by the user. Referring to FIG. 2, while reproducing clip AV stream file 01003.m2ts 133, the reproduction position is changed to clip AV stream file 01006.m2ts 136. Here, if clip AV stream file 01006.m2ts 136 is not yet completely downloaded, a data starved event is generated.

When a BD-J application receives a data starved event, a reproduction status of a playlist is paused to interrupt the reproduction. The data starved event may be addressed in various manners according to applications. For example, reproduction commands may be interrupted to return to a time point before they were given, or the reproduction may be resumed after a predetermined amount of data has been downloaded. However, in either case, if a data starved event is generated, the user's seamless watching of a video may be interrupted.

### SUMMARY

An exemplary embodiment provides a method and apparatus for reproducing network-based contents in a Blu-ray disc (BD)-based reproduction environment by using streaming instead of reproducing contents when the contents are completely downloaded, and an information storage medium storing computer executable instructions for performing the method.

According to an aspect of an exemplary embodiment, there is provided a method of reproducing a playlist by using a reproduction apparatus for an information storage medium, the method comprising: determining whether the playlist is a streaming playlist; when it is determined that the playlist is a streaming playlist: receiving stream data from a server; generating, based on preset standards, a clip AV stream file from the received stream data, and storing the generated clip AV stream file; and reproducing the stored clip AV stream file, wherein the stored clip AV stream file is reproduced based on a network status between the server and the reproduction apparatus.

The preset standards may comprise at least one of a size of the generated clip AV stream file, a maximum number of generated clip AV stream files, and a file naming rule that is shared in the reproduction apparatus.

The playlist may comprise at least one play item, and the play item may include information about a directory where the generated clip AV stream file is to be stored, and the generated clip AV stream file may be stored in the directory based on the information.

The reproducing may comprise reproducing the stored clip AV stream file according to a reproduction sequence.

A stored clip AV stream file which is completely reproduced may be removed from the directory. The directory may be located in a volatile memory.

The method may further comprise: pausing reproduction of the playlist when a data starved event is generated, wherein the data starved event indicates that a clip AV stream file to be reproduced has not yet been prepared in the directory; and resuming the reproduction of the playlist after the clip AV stream file to be reproduced is prepared in the directory.

The method may further comprise: receiving an input to modify a reproduction position of the playlist; when a clip AV stream file corresponding to the modified reproduction position is stored in the directory, reproducing a clip AV stream file corresponding to the modified reproduction position; and removing clip AV stream files corresponding to temporal positions before the modified reproduction position, from the directory.

The method may further comprise: receiving a command for a multi-speed reproduction of the playlist; when the command for the multispeed reproduction of the playlist is received, pausing reproduction of the playlist; receiving stream data for multi-speed reproduction from the server; and sequentially reproducing clip AV stream files for multi-speed reproduction which are generated from the received stream data for multi-speed reproduction.

The method may further comprise: receiving a command for multi-speed reproduction of the playlist; when the command for multi-speed reproduction is received, performing multi-speed reproduction of the clip AV stream file stored in the directory; receiving from the server stream data for multi-speed reproduction of a second clip AV stream file corresponding to a temporal position after the clip AV stream file stored in the directory; generating a multi-speed reproduction clip AV stream file from the received stream data for the multi-speed reproduction of the stored clip AV stream file and storing the generated multi-speed reproduction clip AV stream file in the directory; and when multi-speed reproduction of the multi-speed reproduction clip AV stream file stored in the directory is completed at a temporal point when the command for multi-speed reproduction is received, seamlessly reproducing the stored clip AV stream file for multi-speed reproduction.

According to an aspect of another exemplary embodiment, there is provided an apparatus for reproducing a playlist, comprising: a reader which reads a title of an index file for executing an application, from an information storage medium; a controller which controls the application and determines whether the playlist is a streaming playlist; a communicator which receives stream data from a server in response to determining that the playlist is a streaming playlist; a storage which stores a clip AV stream file that is generated from the received stream data based on preset standards, via the executed application; and a reproducer which reproduces the stored clip AV stream file, wherein the stored clip AV stream file is reproduced according to a network status between the server and the apparatus for reproducing the playlist.

The playlist reproduction apparatus may further comprise an inputter which receives a command related to reproduction of the playlist, wherein when the inputter receives a command that modifies a reproduction position of the playlist, the application determines whether a clip AV stream file corresponding to the modified reproduction position of the playlist is prepared in the directory in order to change a reproduction state of the playlist.

According to an aspect of another exemplary embodiment, there is provided an information storage medium for reproducing audio/video (AV) data, comprising: a title of an index file which executes an application; and a playlist including at least one play item and information indicating whether the playlist is a streaming playlist, wherein the play item includes information about a directory where a clip AV stream file is to be stored, and the application controls reproduction of a clip AV stream file stored in the directory.

### BRIEF DESCRIPTION OF THE DRAWINGS

The above and/or other aspects will become more apparent by describing in detail exemplary embodiments thereof with reference to the attached drawings in which:

FIG. 1 illustrates a situation in which a data starved event is generated when a clip AV stream file that is not completely downloaded is to be reproduced;

FIG. 2 illustrates a situation in which a data starved event is generated because a clip AV stream file to be reproduced is not yet prepared when a user changes a reproduction position;

FIG. 3 illustrates a reproduction system according to an exemplary embodiment;

FIG. 4 illustrates a directory structure of an information storage medium according to an exemplary embodiment;

FIG. 5 is a structural diagram of a server according to an exemplary embodiment;

FIG. 6 is a structural diagram of a reproduction apparatus according to an exemplary embodiment;

FIG. 7A illustrates data added to playlist information in order to indicate whether a playlist is a streaming playlist;

FIG. 7B is a detailed view of the playlist information of FIG. 7A;

FIG. 8 illustrates clip information file information included in a play item of a playlist which includes directory information as to where a clip AV stream file is to be stored;

FIG. 9 illustrates a method of reproducing a clip AV stream file stored in a directory according to an exemplary embodiment;

FIG. 10 is a flowchart illustrating a method of reproducing a streaming playlist according to an exemplary embodiment;

FIG. 11 is a flowchart illustrating a method of reproducing a playlist in the case when a data starved event is generated, according to an exemplary embodiment;

FIG. 12 is a flowchart illustrating a method of reproducing a playlist in a case when a reproduction position is changed during reproduction of the playlist, according to an exemplary embodiment;

FIG. 13 is a flowchart illustrating a method of reproducing a playlist when a command for multi-speed reproduction of a playlist is received, according to an exemplary embodiment; and

FIG. 14 is a flowchart illustrating a method of reproducing a playlist when a command for multi-speed reproduction of a playlist is received, according to another exemplary embodiment.

### DETAILED DESCRIPTION

Hereinafter, exemplary embodiments will be described in detail with reference to the attached drawings.

As used herein, the term “and/or” includes any and all combinations of one or more of the associated listed items. Expressions such as “at least one of,” when preceding a list of elements, modify the entire list of elements and do not modify the individual elements of the list.

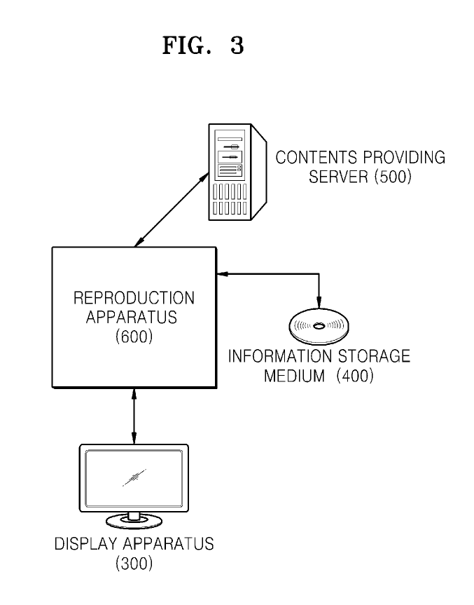

FIG. 3 illustrates a reproduction system according to an exemplary embodiment. The reproduction system includes an information storage medium 400, a contents providing server 500, a playlist reproduction apparatus 600, and a display apparatus 300. The display apparatus 300 may be included in the reproduction apparatus 600 or may be separate from the playlist reproduction apparatus 600. In general, the information storage medium 400 may be an optical disk that is separately included from the reproduction apparatus 600, but may be an inclusive concept that indicates a virtual file system located inside the reproduction apparatus 600.

The reproduction apparatus 600 reads a playlist from the information storage medium 400 and receives a file needed to reproduce the playlist from the server 500 at the same time. In general, the file is a clip AV stream file. However, the playlist may not be necessarily included in the information storage medium 400, but may be received from the server 500. Data read from the information storage medium 400 will be described later. The reproduction apparatus 600 reproduces the playlist, and a decoded clip AV stream file is displayed on the display apparatus 300. The display apparatus 300 can be for example, any kind of television monitor or computer monitor capable of displaying a clip AV stream file.

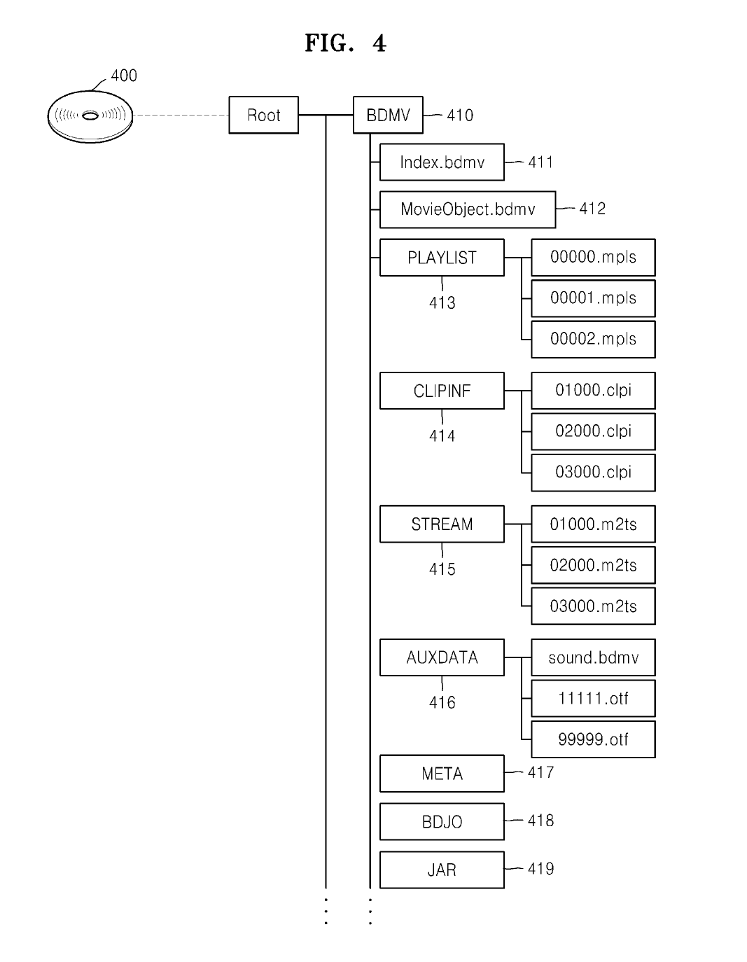

FIG. 4 illustrates a directory structure of the information storage medium 400 according to an exemplary embodiment. The information storage medium 400 may include a Blu-ray disc movie file 410, Index.bdmv 411 which is an index file, MovieObject.bdmv 412 which is a movie object file, a playlist directory PLAYLIST 413, a clip information file directory CLIPINF 414, a clip AV stream file directory STREAM 415, an audio data directory AUXDATA 416, a metadata directory META 417, a BD-J object directory BDJO 418, and an application-related directory JAR 419. However, not all files or directories are required to be present in the information storage medium 400. For example, when reading a playlist from the information storage medium 400, the playlist directory PLAYLIST 413, which is a corresponding playlist, is required to be present; however, when the playlist is downloaded from a server located in a network, the corresponding playlist does not have to be present in the information storage medium 400. However, the above-mentioned directories may be required to be present according to requirements even if no files are included in each of the directories.

The index file such as Index.bdmv 411 includes at least one title. Each title designates one object, and each object is designed to perform a predetermined command. When an object corresponds to a BD-J object, a corresponding title may be a BD-J title. Also, a title may be classified as both a movie title and an interactive title. When a title that designates a BD-J object is executed, at least one application related to the title may be automatically executed. Even if a playlist to be reproduced is not stored in the information storage medium 400, the playlist may be downloaded from a server via an application. Also, while one application is automatically executed in relation to a title, another application for reproduction of a playlist may also be downloaded from a server. In sum, a playlist to be reproduced may be included in the information storage medium 400 or in the server, while an application for controlling reproduction of the playlist is included in the information storage medium 400. Alternatively, both the playlist and the application for controlling reproduction thereof may be located in the server. The information storage medium 400 may be sufficient for storage when it is applied in an application for controlling reproduction of contents of a playlist, a title that is accessible to the playlist, and an application related to the title. Below, a playlist included in the information storage medium 400 will be described as an example.

When a playlist to be reproduced is designated based on the information storage medium 400 or via another path, streamed data corresponding to the playlist is downloaded from the server 500. According to an exemplary embodiment, in order to reduce the probability of a data starved event, image quality or capacity of a stream that is downloaded is modified according to a network environment between the server 500 and the reproduction apparatus 600. For example, if a download speed is lowered to be less than a predetermined reference speed, stream data of low image quality is received. When it is determined that the download speed is sufficient enough so that high quality stream data may be received while simultaneously reproducing a playlist, stream data of a high image quality may be received. Relationships between a download speed and stream data to be received may be varied.

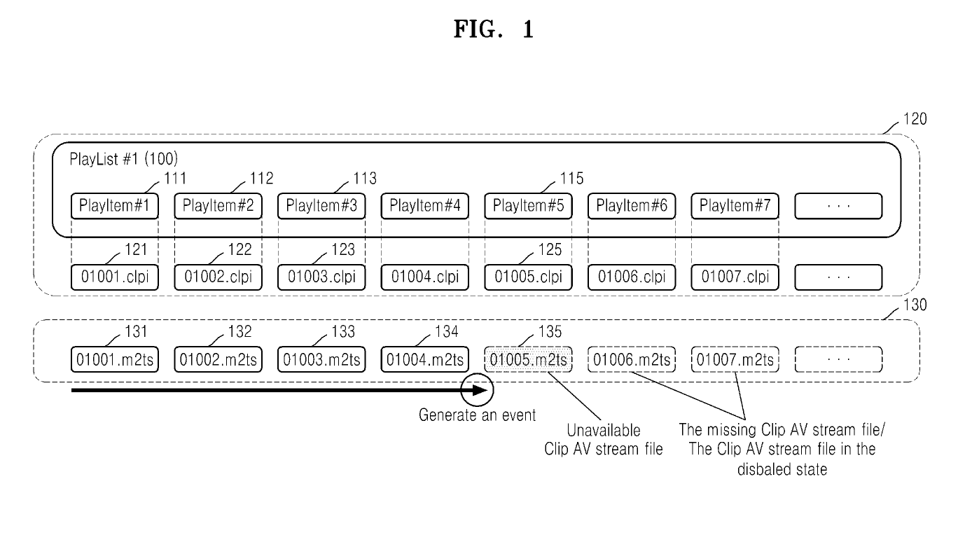

Referring back to FIG. 1, according to the conventional art, assuming a poor network status when playback of the playlist #1 100 begins and up to clip AV stream file 01002.m2ts 132 is reproduced, data is downloaded regardless of the network status. As a result, reproduction of up to clip AV stream file 01004.m2ts 134 is completed before reception of 01005.m2ts 135 is completed, and accordingly, a data starved event is generated.

However, according to an exemplary embodiment, if a network status is degraded to a level at or below a predetermined reference value, stream data to be downloaded from the server 500 is modified. For example, clip AV stream file 01005.m2ts 135 is provided by downloading a data stream having its original content, but at a lower image quality. In this manner, a data starved event may be reduced. In addition, even if there is no change in a network environment, if the amount of time to reproduce all of the clip AV stream files that are completely downloaded has ended, and a currently reproduced reproduction position runs out before all of clip AV stream files have been downloaded, that is, if a data starved event is anticipated, a small capacity version of the clip AV stream file which is about to be downloaded is selected for download to thereby prevent generation of a data starved event. This is useful if a multi-speed reproduction command is input so that a reproduction speed of a playlist is increased above that of a normal (basic) reproduction speed. However, stream data for multi-speed reproduction of the playlist may also be received from the server 500. According to the exemplary embodiment, a user may seamlessly watch an image although there may be a slight change in image quality while watching.

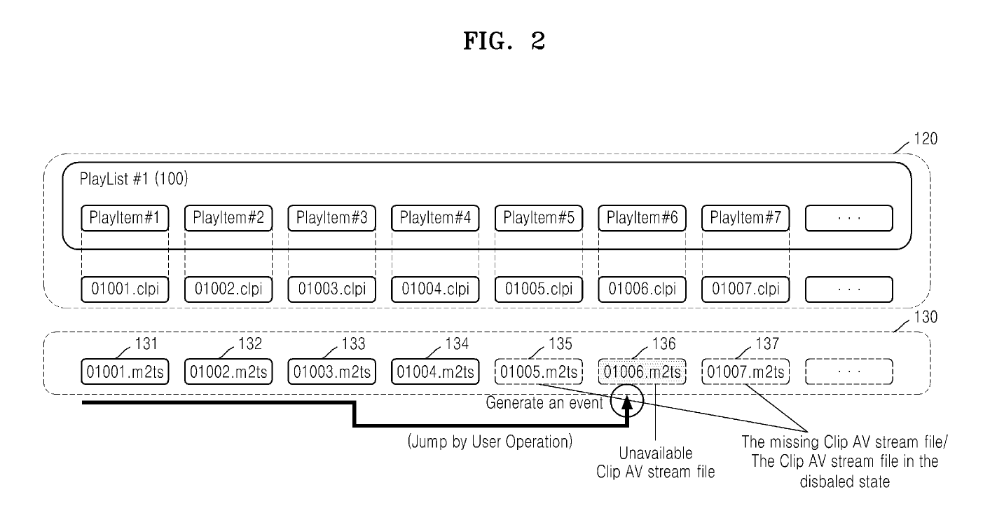

Referring back to FIG. 2, assuming a change of a reproduction position by the user during the reproduction of the playlist #1 100, a situation may arise where a clip AV stream file corresponding to the changed reproduction position has not yet been prepared (i.e. has not yet been downloaded or buffered). In this case, a data starved event is generated. Two methods are provided to solve this problem. First, probability of the data starved event, that is, probability that the clip AV stream file corresponding to the changed reproduction position has not yet been prepared, may be reduced according to a first method. However, if a clip stream corresponding to the changed reproduction position has still not yet been prepared, reproduction is paused, and a second method is utilized to minimize the duration of this interruption.

In the first method, when reproduction of the playlist is started, stream data of a lowermost image quality or a lowermost capacity is first downloaded from the content providing server 500 over the entire reproduction section. When downloading has been completed, stream data having a relatively high image quality or high capacity from a later position than the current reproduction position is downloaded, and used to replace data of a low image quality or low capacity that has been downloaded in advance. According to this method, the probability of having to pause reproduction may be effectively reduced even in situations when a reproduction position is changed during the reproduction.

However, even according to this first method, if a user changes a reproduction position not long after starting the reproduction, a data starved event may still occur. Furthermore, the same may occur under a poor network environment. In case of the second method, if a command for modifying a reproduction position is received, first, stream data of the lowermost image quality or capacity is received regardless of the network environment in order to resume reproduction, and after the reproduction has been conducted for a predetermined reference time, stream data of an appropriate image quality or capacity may be received based on the network environment.

FIG. 5 is a structural diagram of a server 500 according to an exemplary embodiment. The server 500 includes a storage 510, a central processor 520, and a communicator 530. To perform the above-described first or second methods, the storage 510 includes various types of stream data having identical content, but different image qualities. For example, a stream data group 1 511 may store stream data of a low image quality, and a second stream data group 512 may store stream data having the same content, but at a high image quality. Also, the storage 510 may include a group including various stream data according to a particular resolution or a group including stream data for multi-speed reproduction.

The server 500 receives a request for data from the reproduction apparatus 600 via the communicator 530. The communicator 530 may continuously monitor a network status by, for example, an application that is driven in the reproduction apparatus 600. The central processor 520 may determine data to be transmitted to the reproduction apparatus 600 based on the network status to determine which of the stream data stored in the storage 510 is to be transmitted to the reproduction apparatus 600. The determined stream data is transmitted to the reproduction apparatus 600 via the communicator 530. However, the central processor 520 may also transmit requested data to the reproduction apparatus 600 regardless of the network status, should either stream data of a predetermined image quality or capacity or stream data regarding multi-speed reproduction be requested by the reproduction apparatus 600.

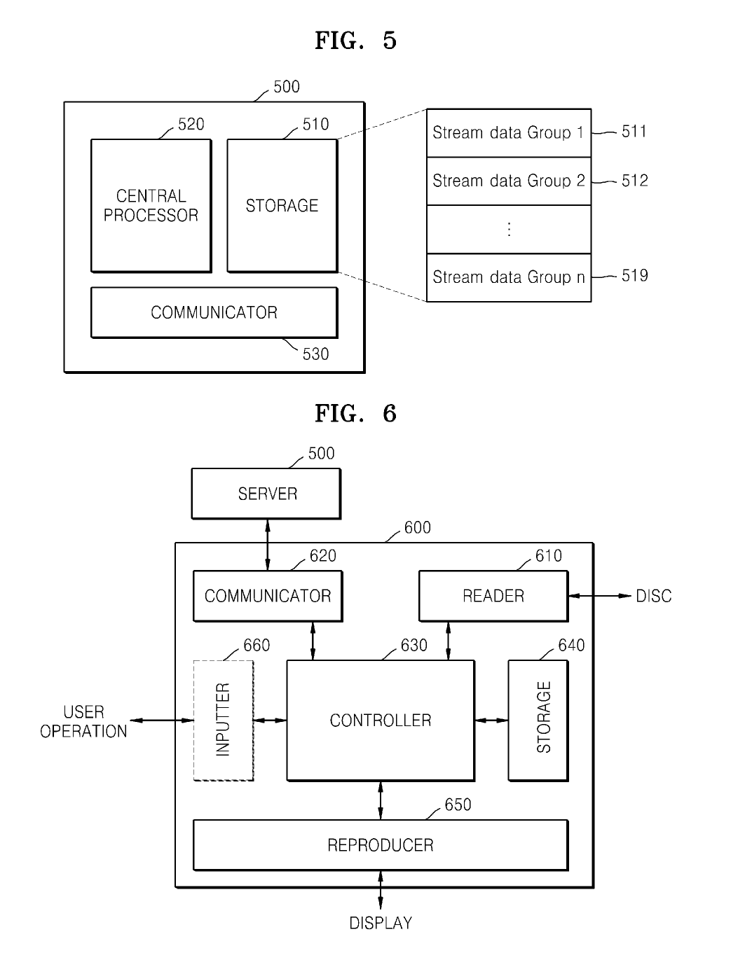

FIG. 6 is a structural diagram of the reproduction apparatus 600 according to an exemplary embodiment. The reproduction apparatus 600 may include a reader 610, a communicator 620, a controller 630, a storage 640, a reproducer 650, and an inputter 660. When the information storage medium 400 is inserted into the reproduction apparatus 600 or executed, the reader 610 loads a title included in the index file 411. Also, the reader 610 may read other applications including an application that is related to a title and which is automatically executed. In the present specification, the applications described above will further be referred to as either a BD-J application or simply as an application. Moreover, the reader 610 may read a playlist file. However, as described above, a playlist file or an application may also be received from the server 500.

The communicator 620 performs data transmission and reception with respect to the server 500. In detail, the communicator 620 transmits a request for data needed by the reproduction apparatus 600 or information regarding a network environment. Also, the communicator 620 receives stream data from the server 500. The communicator 620 may be divided according to functions. For example, the communicator 620 may be formed of a transmitter and a receiver (not shown).

The controller 630 controls an application for reproducing a playlist. In addition, the controller 630 may control other hardware elements of the reproduction apparatus 600. The controller 630 controls an application to measure characteristics of a network environment such as a download speed between the server 500 and the reproduction apparatus 600 or directly transmits an input for controlling playlist reproduction during a user input received by the reproducer from the inputter 660, or transmits an input to the application so that a predefined operation in the application may be transmitted to the reproducer 650. Also, data received from the server 500 may be generated as a clip AV stream file that is suitable for reproduction of a playlist and stored in the storage 640.

The storage 640 is not limited to any particular memory type. Memories such as a hard disk drive (HDD), a solid-state drive (SDD), and a dynamic random access memory (DRAM) may be used as the storage 640. However, according to the exemplary embodiments, a volatile memory such as a DRAM may be used to store clip AV stream files, and clip AV stream files which are completely reproduced may be removed from the volatile memory as necessary to efficiently use data space and system resources.

The reproducer 650 reproduces content in a playlist. A playback control engine that modifies a reproduction status and/or a decoder that decodes a clip AV stream file and displays the contents may be included in the reproducer 650.

The inputter 660 receives a user input. In general, a user input in a BD-based reproduction apparatus is input via a remote control, and a command for modifying a predetermined reproduction status may be interpreted differently according to whether the command is directly transferred to a playback control engine or if the command is indirectly transferred via an application. For example, upon receiving a forward skip (Fwd skip) key, the playback control engine executes a command for moving to a next chapter and reproducing contents on a playlist. However, if a forward skip input is transmitted to an application that is executed in a BD-J interactive title, a command for moving from a current menu item to a next menu item may be executed. Also, when the playback control engine receives a chapter search command, in general, a reproduction position is moved to start reproduction at a designated chapter. When reproduction is conducted in this manner, probability of a data starved event is high. However, when a chapter search command is transmitted to an application, a data starved event may be prevented if the application does not move the reproduction position to a designated chapter immediately after receiving a command but instead first prepares a clip AV stream file by downloading stream data at a corresponding reproduction position (i.e. generates a buffer), followed by movement of the reproduction position to the designated chapter and then starting reproduction.

That is, when reproducing a playlist, in order to handle an input related to reproduction or generation of an event indirectly by using the controller 630 or an application that is controlled by using the controller 630 (i.e. not directly by the playback control engine or the reproducer 650), a corresponding playlist is to be distinguished from other playlists that are reproduced in general.

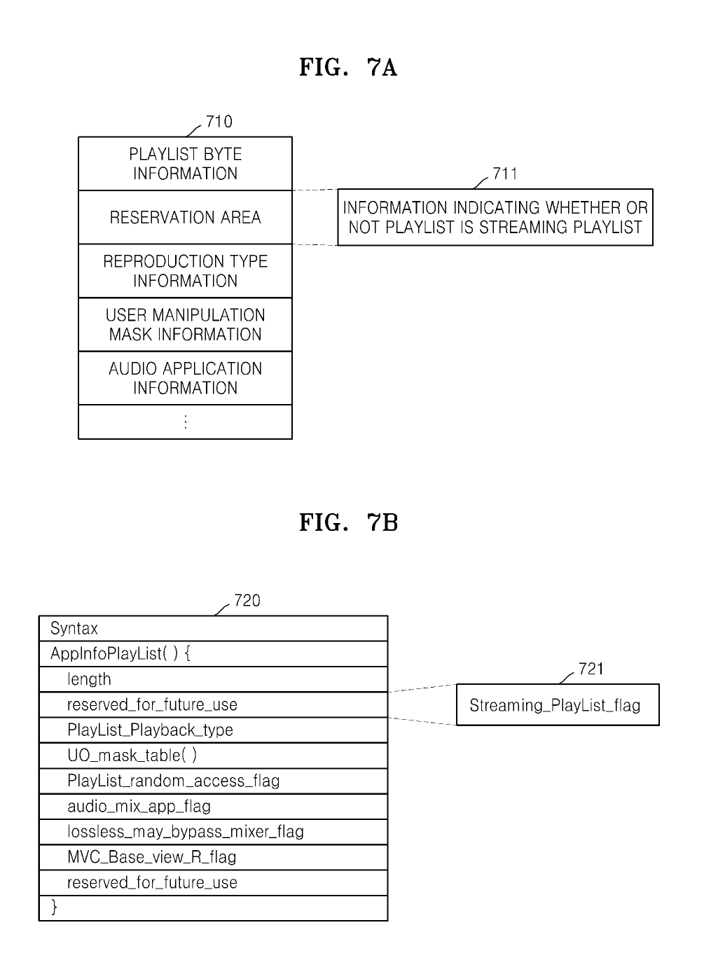

FIG. 7A illustrates data added to playlist information in order to indicate whether the playlist is a streaming playlist. In general, information 710 related to a playlist includes information about a capacity of the playlist, reproduction type information, user manipulation mask information, and audio application information. The information 710 may be configured to include information 711 indicating whether the playlist is a streaming playlist, in the preliminary area or reservation area of the information 710. If the playlist is a streaming playlist, a time search, a chapter search, a forward/backward play (fwd/bwd play) or the like are directly transferred to an application. If the playlist is not a streaming playlist, the playlist may be reproduced in the same manner as a progressive playlist according to the conventional art. FIG. 7B is a detailed view of the playlist information of FIG. 7A. The information 710 holds information about a playlist and corresponds to AppInfoPlaylist 720, and the information 711 indicates whether the playlist is a streaming playlist and corresponds to Streaming_PlayList_flag 721. The Streaming_PlayList_flag 721 may have data of 1 bit, in which a value of 0 may represent “true” and a value of 1 may represent “false”, or vice versa.

However, according to the conventional art, a clip AV stream file has to be a file designated in a clip information file, and thus even if clip AV stream files of different image qualities are provided based on a network environment according to the above-described methods, the reproducer 650 may still not be able to reproduce a playlist. Accordingly, a new method of reproducing a clip AV stream file is provided. According to the exemplary embodiment, the reproducer 650 may store the stream data received from the server 500 as reproducible files in the storage 640. The size, maximum number, and name of clip AV stream files that are to be stored may be determined by a BD-J application. However, since it is sufficient when the reproducer 650 is able to reproduce a clip AV stream file that is generated and stored by an application, then predetermined standards such as the naming rule of file names are also sufficient if they can be shared between the reproducer 650 and the controller 630 or between the playback control engine and the application.

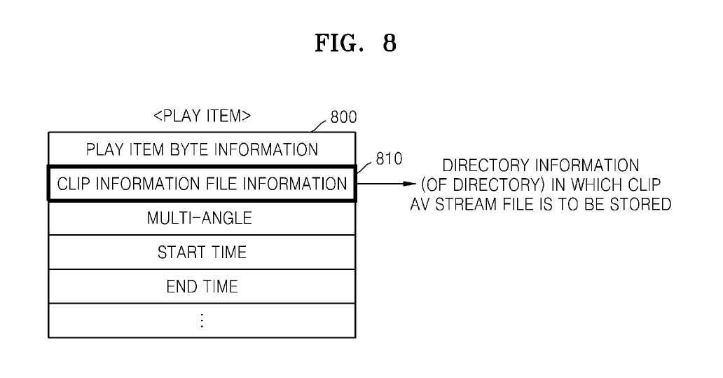

FIG. 8 illustrates clip information file information included in a play item of a playlist which indicates predetermined directories in which a clip AV stream file is to be stored. A playlist includes at least one play item, and each play item includes information of a clip information file (e.g., clip_information_file_name). This information allows that only a predetermined directory is indicated and a clip information file is not indicated. When the application generates clip AV stream files according to a reproduction sequence and locates the same in a predetermined directory, the playback control engine may reproduce the clip AV stream files according to the reproduction sequence and store them in the predetermined directory. Here, the application and the playback control engine share directory information in which clip AV stream files are stored and directory information from which a clip AV stream file to be reproduced is to be opened.

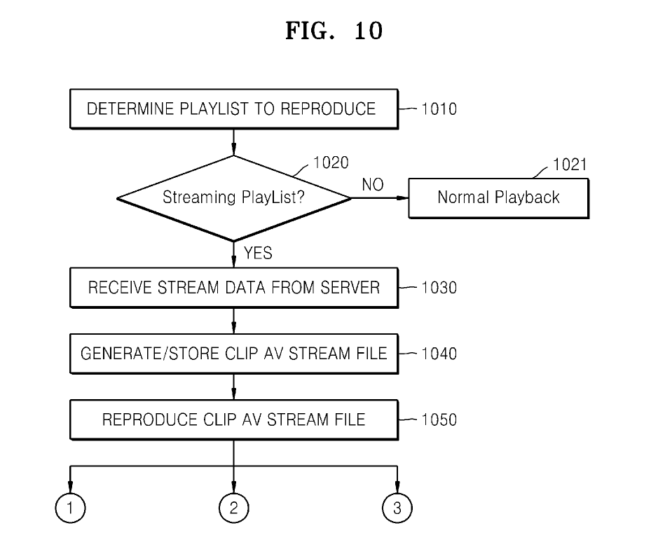

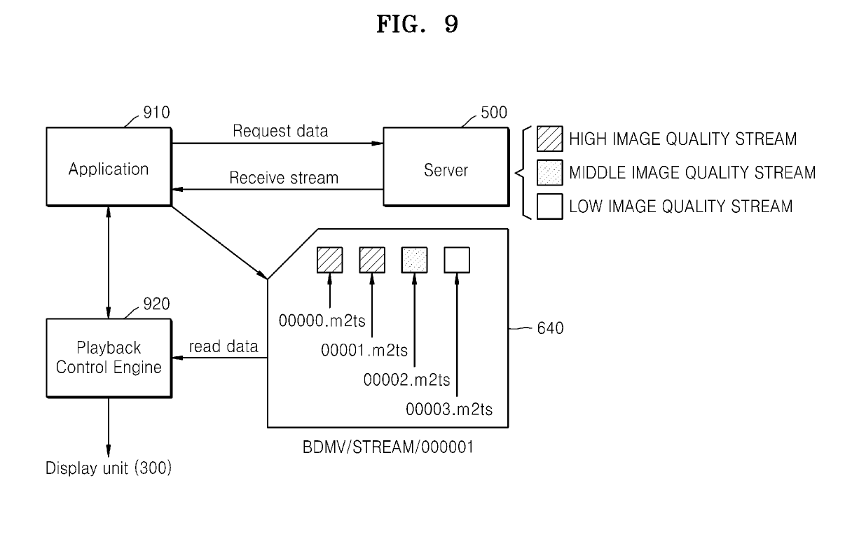

FIG. 9 illustrates a method of reproducing a clip AV stream file stored in a directory. An application 910 checks whether a playlist is a streaming playlist, and then requests data from the server 500. If the playlist is not a streaming playlist, the playlist may be reproduced according to the conventional method of reproducing a playlist, that is, a progressive playlist. The server 500 keeps data streams including identical contents, based on image quality, capacity, resolution, or the like. For convenience of understanding, it is assumed here that the server 500 includes streams of a high image quality, a middle image quality, and a low image quality. Upon receiving data from the reproduction apparatus 600, appropriate data is transmitted to the reproduction apparatus 600 in consideration of a network state, a reproduction status, an operation of the application 910 or the like. Also, for convenience of description, a network environment will be divided into high, middle, and low quality, and it will be assumed that stream data of high, middle, and low image quality are transmitted to the network environment of a high, middle, and low quality, respectively.

Data transmitted from the server 500 may be in a form of a clip AV stream file, that is, a file having an extension in the form of m2ts. That is, only a file name or a storage location of stream data transmitted from the server 500 is adjusted by an application but the stream data itself may be reproduced by using the reproducer 650. However, the form of the clip AV stream file is not limited thereto, and the form of stream data stored in the server 500 is also not limited. The form of the stream data is sufficient when stream data is in a form that may be generated as a clip AV stream file of a form that is reproducible by the reproduction apparatus 600 and may be shared with the playback control engine 920 and stored in the storage 640.

The application 910 generates the received stream data as a clip AV stream file according to predetermined standards and stores the same in a directory of the storage 640. The directory 640 refers to the directory designated by the play item according to FIG. 8. For example, the clip AV stream file may be stored in a directory “BDMV/STREAM/000001/” of RAM drive R:\. In this operation, a method of using a virtual file system and/or a binder may be used. In a situation where a network status is good initially but degrades over time, the clip AV stream file stored in the directory may sequentially be of a high image quality, a middle image quality, and a low image quality. When the application forms files according to the reproduction sequence and locates them in a directory as described above, the playback control engine 920 may reproduce the files according to the sequence. Also, when one file is completely reproduced, the playback control engine 920 notifies the application that reproduction is complete. The application may adjust the total memory capacity according to use capacity of the memory, for example, by removing files which have been completely reproduced. When the reproduction position is modified, the application may remove all previously generated clip AV stream files and download new stream data to generate new clip AV stream files so that the playback control engine may reproduce a new file.

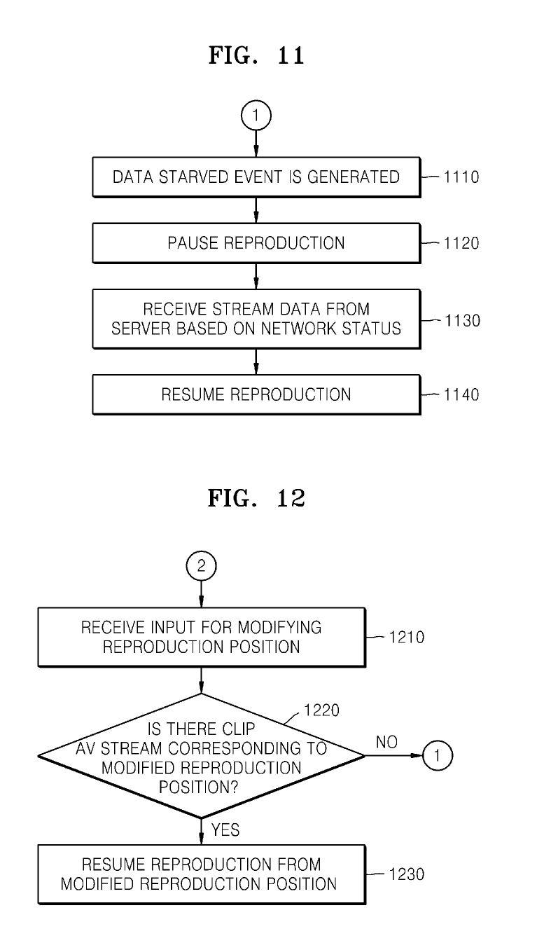

FIG. 10 is a flowchart illustrating a method of reproducing a streaming playlist according to an exemplary embodiment. In operation 1010, a playlist, which is to be reproduced, is determined. The playlist may be contained in the image storage medium 400 or may be received from the server 500 as described above. When the playlist to reproduce is determined, it is determined in operation 1020 whether the playlist is a streaming playlist. If the playlist is not a streaming playlist, the method proceeds to operation 1021 and the playlist may be reproduced according to a method of the conventional art. If the playlist is a streaming playlist, the method proceeds to operation 1030, and the controller 630 receives stream data from the server 500. Although stream data of an appropriate image quality and/or capacity is received based on a network status, as described above, stream data of the lowest quality and/or smallest capacity may be received regardless of the network status according to reproduction situations. Additional operations according to each situation will be described below with reference to FIGS. 11 through 14, and descriptions already provided above will not be repeated.

In operation 1040, the reproduction apparatus 600 generates a clip AV stream file from the received stream data according to predetermined standards and stores the clip AV stream file in a predetermined directory. The stored clip AV stream file is reproduced according to a user input or an operation of the application in operation 1050.

FIG. 11 is a flowchart illustrating a method of reproducing a playlist in a case where a data starved event is generated, according to an exemplary embodiment. When a data starved event is generated in operation 1110, the reproducer 650 pauses reproduction in operation 1120 and notifies the controller 630. Then, in operation 1130, the controller 630 receives stream data from the server 500 based on a network environment. Then, once a clip AV stream file has been generated and stored according to the above-described method, reproduction is resumed in operation 1140.

FIG. 12 is a flowchart illustrating a method of reproducing a playlist in a case where a reproduction position is changed during reproduction of the playlist, according to an exemplary embodiment. In operation 1210, an input for modifying a reproduction position is received via a user input. In operation 1220, it is determined whether a clip AV stream file corresponding to the modified reproduction position exists in the directory. If it does not exist, the method proceeds to \textcircled{1} of FIG. 11 and a data starved event is generated in 1110 of FIG. 11. In operation 1230, when there is a clip AV stream file corresponding to the modified reproduction position, reproduction is resumed starting from the modified reproduction position. Here, clip AV stream files corresponding to positions before the modified reproduction position may be removed from the directory, thereby efficiently managing memory capacity.

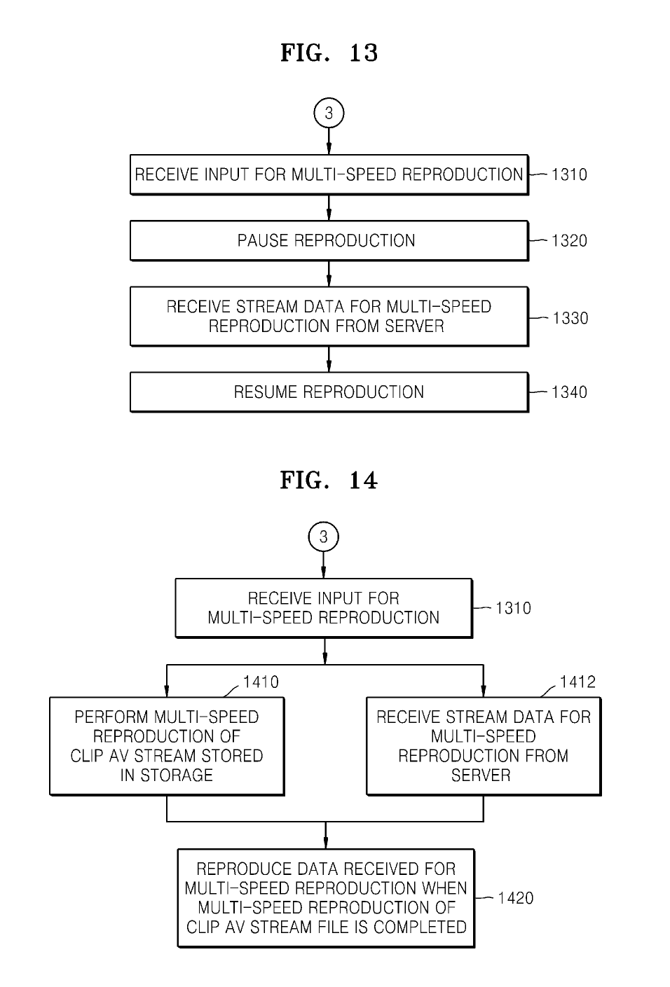

FIG. 13 is a flowchart illustrating a method of reproducing a playlist in a case where a command for multi-speed reproduction of a playlist is received, according to an exemplary embodiment. When an input for multi-speed reproduction is received in operation 1310, reproduction is paused in operation 1320, and stream data for multi-speed reproduction is then received from a server (for example, from server 500) in operation 1330. The server may include stream data for multi-speed reproduction according to various image qualities or capacities of the stream data. In this case, a stream of the smallest capacity suited for multi-speed reproduction according to conditions of a network environment may be received. When a clip AV stream file for multi-speed reproduction is generated from the received stream data and stored as described above, reproduction is resumed in operation 1340.

FIG. 14 is a flowchart illustrating a method of reproducing a playlist in the case when a command for multi-speed reproduction of a playlist is received, according to another exemplary embodiment. When an input for multi-speed reproduction is received in operation 1310, multi-speed reproduction of the clip AV stream files that are stored in the storage 640 up to the point when the input is received is performed based on the input in operation 1410. At the same time, stream data for multi-speed reproduction corresponding to a reproduction section at a point after the clip AV stream files stored in the storage 640 is received from the server 500 in operation 1412. After reproducing all clip AV stream files that exist up to the point of receiving the input, a clip AV stream file for multi-speed reproduction is reproduced seamlessly in operation 1420.

According to an exemplary embodiment, by receiving data of an appropriate capacity based on a network environment, probability of a data starved event may be effectively reduced.

Also, according to an exemplary embodiment, even when a reproduction position of a playlist is changed so that reproduction is paused, reproduction may be quickly resumed.

Also, according to an exemplary embodiment, disadvantages in terms of reproduction of a conventional progressive playlist may be compensated. That is, not only clip AV stream files that are designated in advance are reproduced but clip AV stream files may be modified according to a network environment or a user input so as to reproduce the clip AV stream files. Also, portions of a clip AV stream file that are not downloaded may also be reproduced by using a BD-J application.

The block diagrams disclosed in an exemplary embodiments may be construed by a person of ordinary skill in the art in a form for conceptually expressing circuits for implementing the principles of an exemplary embodiment. Further, it is obvious to a person of ordinary skill in the art that a flowchart, a status transition view, a pseudo-code, or the like, may be substantially expressed in a computer-readable medium to denote various processes which can be executed by a computer or a processor whether the computer or the processor is clarified. Thus, the foregoing exemplary embodiments may be created as programs which can be executed by computers and may be implemented in a general digital computer operating the programs by using a computer-readable recording medium. The computer-readable medium may include storage mediums such as a magnetic storage medium (e.g., a ROM, a floppy disk, a hard disk, or the like), an optical reading medium (e.g., a CD-ROM, a DVD, or the like).

Functions of various elements illustrated in the drawings may be provided by the use of dedicated hardware as well as by hardware which is related to appropriate software and can execute the software. When provided by a processor, such functions may be provided by a single dedicated processor, a single shared processor, or a plurality of individual processors which can share some of the functions. Also, the stated use of terms “processor” or “controller” should not be construed to exclusively designate hardware which can execute software and may include digital signal processor (DSP) hardware, a ROM for storing software, a RAM, and a non-volatile storage device, without any limitation.

In the claims, the elements for performing particular functions may cover a certain method performing a particular function, and such elements may include a combination of circuit elements performing particular functions, or software in a certain form including firmware, microcodes, or the like, combined with appropriate circuits to perform software for performing particular functions.

Designation of ‘an exemplary embodiment’ and various modifications of such an expression may mean that particular features, structures, characteristics, and the like, in relation to this exemplary embodiment are included in at least one exemplary embodiment. Thus, the expression ‘an exemplary embodiment’ and any other modifications disclosed throughout the entirety of the disclosure may not necessarily designate the same exemplary embodiment.

In the specification, in a case of ‘at least one of A and B’, the expression of ‘at least one among ˜’ is used to cover only a selection of a first option (A), only a selection of a second option (B), or a selection of both options (A and B). In another example, in a case of ‘at least one of A, B, and C’, the expression of ‘at least one among ˜’ is used to cover only a selection of a first option (A), only a selection of a second option (B), only a selection of a third option (C), only a selection of the first and second options (A and B), only a selection of the second and third options (B and C), or a selection of all of the three options (A, B, and C). When even more items are enumerated, it will be obvious to a person of ordinary skill in the art that those items can be definitely extended.

While exemplary embodiments have been particularly shown and described, it will be understood by one of ordinary skill in the art that various changes in form and details may be made therein without departing from the spirit and scope of the inventive concept as defined by the following claims. The exemplary embodiments should be considered in a descriptive sense only and not for purposes of limitation. Therefore, the scope of the inventive concept are defined not by the detailed description but by the following claims, and all differences within the scope will be construed as being included in the inventive concept.

What is claimed is:

1. A method of reproducing a playlist using a reproduction apparatus of an information storage medium, the method comprising:
determining whether the playlist is a streaming playlist;
when it is determined that the playlist is a streaming playlist:
receiving stream data from a server;
generating, based on preset standards, a clip audio/video (AV) stream file from the received stream data;
storing the generated clip AV stream file; and
reproducing the stored clip AV stream file,
wherein the stored clip AV stream file is reproduced based on a network status between the server and the reproduction apparatus.

2. The method of claim 1, wherein the preset standards comprise at least one of a size of the generated clip AV stream file, a maximum number of generated clip AV stream files, and a file naming rule that is shared in the reproduction apparatus.

3. The method of claim 1, wherein the playlist comprises at least one play item, and the play item includes information about a directory where the generated clip AV stream file is to be stored, and the generated clip AV stream file is stored in the directory based on the information.

4. The method of claim 3, wherein the reproducing comprises reproducing the stored clip AV stream file according to a reproduction sequence.

5. The method of claim 3, wherein when the stored clip AV stream file is completely reproduced, the stored clip AV stream file is removed from the directory.

6. The method of claim 3, wherein the directory is located in a volatile memory.

7. The method of claim 3, further comprising:
pausing reproduction of the playlist when a data starved event is generated, wherein the data starved event indicates that a clip AV stream file to be reproduced has not yet been prepared in the directory; and
resuming the reproduction of the playlist after the clip AV stream file to be reproduced is prepared in the directory.

8. The method of claim 3, further comprising:
receiving an input to modify a reproduction position of the playlist;
when a clip AV stream file corresponding to the modified reproduction position is stored in the directory, reproducing a clip AV stream file corresponding to the modified reproduction position; and
removing clip AV stream files corresponding to temporal positions before the modified reproduction position, from the directory.

9. The method of claim 3, further comprising:
receiving a command for a multi-speed reproduction of the playlist;
when the command for the multi-speed reproduction of the playlist is received, pausing reproduction of the playlist;
receiving stream data for multi-speed reproduction from the server; and
sequentially reproducing clip AV stream files for multi-speed reproduction which are generated from the received stream data for multi-speed reproduction.

10. The method of claim 3, further comprising:
receiving a command for multi-speed reproduction of the playlist;
when the command for multi-speed reproduction is received, performing multi-speed reproduction of the clip AV stream file stored in the directory;
receiving from the server stream data for multi-speed reproduction of a second clip AV stream file corresponding to a temporal position after the clip AV stream file stored in the directory;
generating a multi-speed reproduction clip AV stream file from the received stream data for the multi-speed reproduction of the stored clip AV stream file and storing the generated multi-speed reproduction clip AV stream file in the directory; and
when multi-speed reproduction of the multi-speed reproduction clip AV stream file stored in the directory is completed at a temporal point when the command for multi-speed reproduction is received, seamlessly reproducing the stored clip AV stream file for multi-speed reproduction.

11. An apparatus for reproducing a playlist, the apparatus comprising:
a reader which reads a title of an index file for executing an application, from an information storage medium;
a controller which controls the application and determines whether the playlist is a streaming playlist;
a communicator which receives stream data from a server in response to determining that the playlist is a streaming playlist;
a storage which stores a clip audio/video (AV) stream file that is generated from the received stream data based on preset standards, via the executed application; and
a reproducer which reproduces the stored clip AV stream file,
wherein the stored clip AV stream file is reproduced according to a network status between the server and the apparatus for reproducing the playlist.

12. The playlist reproduction apparatus of claim 11, wherein the preset standards comprise at least one of a size of the clip AV stream file, a maximum number of generated clip AV stream files, and a file naming rule that is shared in the reproduction apparatus.

13. The playlist reproduction apparatus of claim 11, wherein the playlist comprises at least one play item, and the play item includes information about a directory where the generated clip AV stream file is to be stored, and the generated clip AV stream file is stored in the directory based on the information.

14. The playlist reproduction apparatus of claim 13, wherein when the stored clip AV stream file is completely reproduced, the stored clip AV stream file is removed from the directory of the storage.

15. The playlist reproduction apparatus of claim 13, wherein the storage which includes the directory is a volatile memory.

16. The playlist reproduction apparatus of claim 13, wherein when a data starved event is generated, the data starved event indicates that a clip AV stream file, that is to be decoded by using the reproducer, has not yet been prepared in the directory, the application pauses reproduction of the playlist, and once a clip AV stream file to be decoded is prepared in the directory, the application resumes the reproduction of the playlist.

17. The playlist reproduction apparatus of claim 11, further comprising an inputter which receives a command related to reproduction of the playlist,
wherein when the inputter receives a command that modifies a reproduction position of the playlist, the application determines whether a clip AV stream file corresponding to the modified reproduction position of the playlist is prepared in the directory in order to change a reproduction state of the playlist.

18. A non-transitory computer readable information storage medium which reproduces audio/video (AV) data, comprising:
a title of an index file which executes an application; and
a playlist including at least one play item and information indicating whether the playlist is a streaming playlist,
wherein the play item includes information about a directory where a clip AV stream file is to be stored, and the application controls reproduction of a clip AV stream file stored in the directory.

19. The non-transitory computer-readable information storage medium of claim 18, wherein the stored clip AV stream file is generated from stream data that is received according to a network status between a server and a reproduction apparatus and according to preset standards by using the application.

20. A non-transitory computer-readable storage medium having embodied thereon a program, which when executed by a computer, performs a method, the method comprising:
determining whether the playlist is a streaming playlist;
when it is determined that the playlist is a streaming playlist:
receiving stream data from a server;
generating, based on preset standards, a clip audio/video (AV) stream file from the received stream data, and storing the generated clip AV stream file; and
reproducing the stored clip AV stream file,
wherein the stored clip AV stream file is reproduced based on a network status between the server and the reproduction apparatus.
